(19) United States
(12) Patent Application Publication
(10) Pub. No.: US 2008/0300860 A1
(43) Pub. Date: Dec. 4, 2008

(54) Language translation for customers at retail locations or branches

(75) Inventors: Ian Marlow, Pine Brook, NJ (US); Albert J. Gottlieb, White Plains, NY (US)

Correspondence Address: LAW OFFICE OF LEO ZUCKER, 2591 Duning Drive, PO BOX 1177, Yorktown Heights, NY, 10598, US

(73) Assignee: RGB Translation, LLC

(21) Appl. No.: 11/809,504

(22) Filed: Jun. 1, 2007

(51) Int. Cl. G06F 17/20

(52) U.S. Cl. 704/8

(57) ABSTRACT

One or more kiosks are provided at a retail establishment or branch. Each kiosk includes first audio and video equipment for linking with a given network and for enabling persons at a kiosk to communicate with a selected language interpreter located off site. Second audio and video equipment is provided at the site of the interpreter for linking with the given network and for enabling the interpreter to communicate by voice and image with the persons at the kiosk. A processing unit associated with the network is configured and programmed for (a) accessing a database representing a number of language interpreters, (b) selecting a certain interpreter from the database in response to a language choice entered by a person at the kiosk, and (c) connecting the first audio and video equipment at the kiosk with the second audio and video equipment of the selected interpreter through the given network.

### BACKGROUND OF THE INVENTION

1. Field of the Invention

This invention concerns a method and a system for providing language translation services over one or more communication networks.

2. Discussion of the Known Art

Many retail establishments or locations such as, for example, branches of banks, often must deal with potential new customers who have little if any fluency in the English language. Accordingly, there is a genuine need on the part of these establishments to be able to communicate with such customers in their own language on site, with respect to the products or services offered by the establishments. Yet, it is not feasible for most establishments to ensure that someone is always available during business hours solely for the purpose of conversing with customers in any one of a number of different foreign languages.

U.S. Pat. No. 5,392,343 (Feb. 21, 1995) relates to a system for on demand language interpretation, wherein a calling party, an interpreter, and the called party are bridged with one another during a telephone call. Also, U.S. Pat. No. 5,794,218 (Aug. 11, 1998) discloses a system that enables telephone-based interactive financial transactions in multiple languages. When a customer's language and home country are identified, the patented system connects the customer by telephone with a representative who can speak the customer's language and authorize the transaction by accessing the customer's records. A known current provider of telephonic interpretation services is Language Learning Enterprises, Inc. (LLE) in Winchester, Va.

U.S. Patent Application Publication No. 2005/0251421 (Nov. 10, 2005) relates to a method of providing interpreting services for facilitating communications between a patient and a health-care provider at a health-care organization, wherein the patient uses a wireless video conferencing device to communicate with an interpreter located outside of the organization.

A number of known U.S. patent applications assigned to Glowpoint, Inc. of Hillside, N.J., relate to video teleconferencing via the Internet. See, e.g., U.S. Patent Application Publications No. 2006/0253895 (Nov. 9, 2006); No. 2005/0180400 (Aug. 18, 2005); No. 2005/0177718 (Aug. 11, 2005); No. 2005/0174947 (Aug. 11, 2005); No. 2005/0105711 (May 19, 2005); and No. 2005/0105465 (May 19, 2005). None of the mentioned publications deals specifically with the matter of language translation, however. With respect to the use of the Internet for transmission of high quality or professional video over Internet Protocol (VOIP), see generally, <http://en.wikipedia.org/wiki/Professional_video_over_IP>.

### SUMMARY OF THE INVENTION

According to one aspect of the invention, a language translation system has one or more kiosks arranged at a retail establishment or branch, wherein a given kiosk includes first audio and video equipment for linking with a given network and for enabling persons at the kiosk to communicate with a selected language interpreter located off site. Second audio and video equipment is arranged at the site of the interpreter for linking with the given network and for enabling the interpreter to communicate by voice and image with the persons at the kiosk. A processing unit associated with the network is configured and programmed for (a) accessing a database representing a number of language interpreters, (b) selecting a certain interpreter from the database in response to a language choice entered by a person at the kiosk, and (c) connecting the first audio and video equipment at the given kiosk with the second audio and video equipment of the selected interpreter through the given network.

According to another aspect of the invention, a method of performing language translation services includes arranging one or more kiosks at a retail establishment or branch, and providing a given kiosk with first audio and video equipment for linking with a given network. Second audio and video equipment is provided at sites of a number of language interpreters for linking the interpreters with the given network. The method also includes accessing a database representing the language interpreters, selecting a certain interpreter from the database in response to a language choice entered by a person at the kiosk, and connecting the first audio and video equipment at the kiosk with the second audio and video equipment of the selected interpreter through the given network. Thus, persons at the kiosk can communicate with the selected language interpreter, and the interpreter can communicate by voice and image with the persons at the kiosk.

For a better understanding of the invention, reference is made to the following description taken in conjunction with the accompanying drawing and the appended claims.

### BRIEF DESCRIPTION OF THE DRAWING

In the drawing:

FIG. 1 is a flow chart illustrating steps for carrying out a video based language translation service, according to the method of the invention;

FIG. 2 is a graphic representation of a first embodiment of a video based language translation system, according to the invention;

FIG. 3 is a graphic representation of a second embodiment of a video based language translation system, according to the invention;

FIG. 4 is a graphic representation of a third embodiment of a video based language translation system, according to the invention;

FIG. 5 is a graphic representation of a fourth embodiment of a video based language translation system, according to the invention;

FIG. 6 is a graphic representation of a fifth embodiment of a video based language translation system, according to the invention; and

FIG. 7 is a graphic representation of a sixth embodiment of a video based language translation system, according to the invention.

### DETAILED DESCRIPTION OF THE INVENTION

The present invention allows individuals at retail establishments or branches, for example, a bank branch manager and a non-English speaking customer, to communicate with one another on site using a professional language interpreter who may be located remotely off-site. This live language translation service is carried out, in the illustrated embodiments, by arranging one or more kiosks at the branch wherein each kiosk is equipped to transmit the voice and image of the manager and the customer over, e.g., a Video Over Internet Protocol (VOIP) network to an interpreter who is fluent in the customer's spoken language and who is also equipped to link with the network. Accordingly, the voice and the image of the interpreter may be heard and seen substantially in real time by the manager and customer at the kiosk. In addition to or instead of the public Internet, private high-bandwidth networks or links may also be used as described herein.

In a typical application, a customer has a question concerning the services of a retail establishment and would prefer to have the question answered in his or her own language. The customer and a designated employee (e.g., a manager) of the establishment sit together at a kiosk, the employee enters the customer's language, an available interpreter is contacted, and the customer communicates the question in his or her own language to the interpreter. The interpreter communicates an English translation of the customer's question to the employee at the kiosk, who in turn responds in English to the interpreter. The interpreter then communicates the employee's response as translated into the customer's language back to the customer at the kiosk, and awaits a further question or response (if any) from the customer.

In addition to a number of different spoken languages, interpreters capable of understanding and translating sign language may also be made available for those customers having such a requirement. The use of a sufficiently high bandwidth video link between a sign language interpreter and the customer ensures that either one of them can view the other's mouth, hand and other gestures substantially in real time in order to facilitate proper translation.

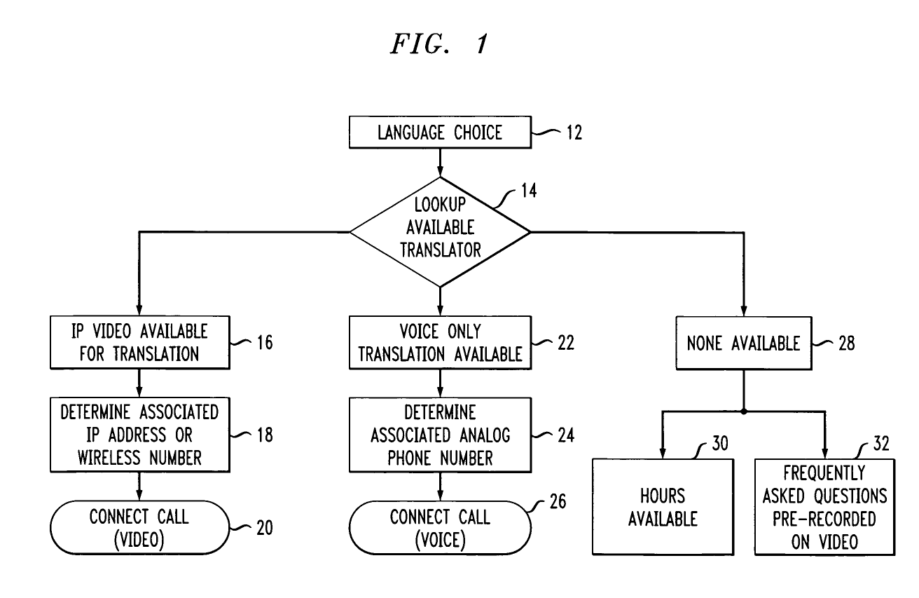

FIG. 1 is a flow chart depicting the operation of one embodiment of the inventive language translation system. For example, a bank branch manager and a potential new customer sit together at a kiosk that is set up at the bank branch. The kiosk includes a conventional video display monitor having, e.g., a touch sensitive screen, and such commercially available audio and video equipment (e.g., a microphone, speaker and camera) as to enable the manager and customer to link with one or more networks for communicating by voice and image with a language interpreter who is located off site and can also link with the networks. In step 12, the manager chooses the language of the customer by, for example, touching a corresponding language button that is displayed among a number of different available language buttons on the monitor screen.

Once a language choice is entered, an associated network processing unit selects an interpreter whose hours of availability (which may have been entered previously by the interpreter) coincide with the time of the request (step 14). If the interpreter is equipped for two-way video translation (step 16), the interpreter is contacted either on-line (e.g., via an associated IP address) or by an automated call to the interpreter's wireless telephone number (step 18). Once the interpreter responds, he or she then communicates with the manager and the customer at the kiosk using commercially available voice and camera equipment at the interpreter's location (step 20).

If an interpreter is available for voice-only translation (step 22), the system contacts the interpreter, for example, by calling the interpreter's analog (wired) telephone number (step 24). Once the interpreter responds, he or she is then linked to communicate by voice through the interpreter's telephone with the manager and the customer at the kiosk (step 26).

If no interpreter is currently available for the chosen language (step 28), the hours (in the branch's local time) during which an interpreter is available are displayed on the monitor screen at the kiosk (step 30). A pre-recorded video of questions frequently asked by branch customers with corresponding answers in the chosen language, may also be viewed at the kiosk on the monitor screen (step 32).

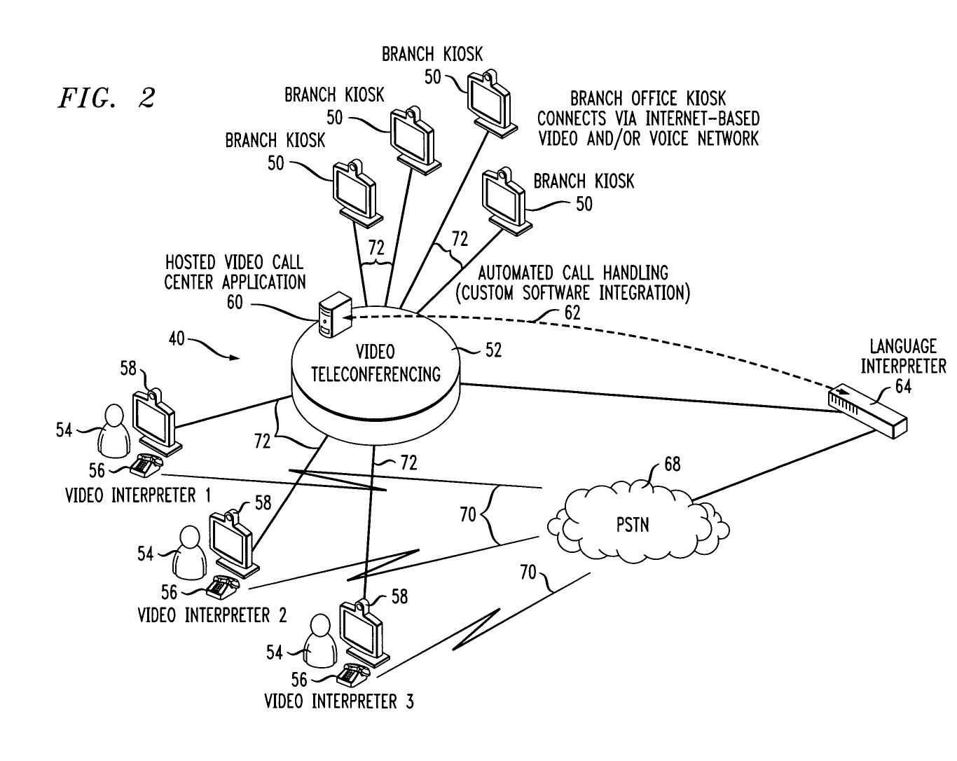

FIG. 2 shows a first embodiment of a language translation system 40 according to the invention. A number of kiosks 50 are arranged at a retail location or branch of an established business such as, without limitation, a bank. Each kiosk 50 can be linked via the Internet or other network having enough capacity to handle professional quality video, with a video teleconferencing provider 52 such as, e.g., the earlier mentioned Glowpoint, Inc. The teleconferencing provider 52 may also link with a selected one of a number of professional language interpreters 54 each of which has a telephone 56 connected to a public switched telephone network (PSTN) 68 via telephone lines 70. Commercially available, high quality audio and video equipment 58 that is capable of linking with the teleconferencing provider 52 via the Internet or other high bandwidth network, is also provided for each interpreter 54.

Specifically, the teleconferencing provider 52 runs a call center application on an associated processing unit 60. The processing unit 60 is configured and programmed to connect via a bridge or circuit 62 with a network of a language interpreter provider 64 such as, for example, the earlier mentioned Language Learning Enterprises, Inc. (LLE). Once connected, the processing unit 60 operates to (a) access those the interpreters 54 who have indicated to the provider 64 their availability to participate as a language interpreter in the inventive system 40, and to (b) initiate calls to selected interpreters through the provider 64 and the PSTN 68. That is, the bridge 62 enables performance of the automated interpreter selection step 14 and the subsequent call handling steps in FIG. 1, using a database of available interpreters 54 established and maintained by the language interpreter provider 64.

Once an interpreter 54 responds to a call over the PSTN 68 from the interpreter provider 64, the teleconferencing provider 52 links the audio and video equipment 58 of the interpreter with the audio and video equipment at the kiosk 50 from which the call was initiated, via high bandwidth links 72. When no video option is available (e.g., the only available interpreter lacks operating video equipment), the PSTN 68 allows for voice-only language translation services using the telephone lines 70 between the interpreter provider 64 and the interpreter's wired telephone 56, the bridge 62 with the teleconferencing provider 52, and the link 72 between provider 52 and the kiosk 50. See steps 22, 24 and 26, in FIG. 1.

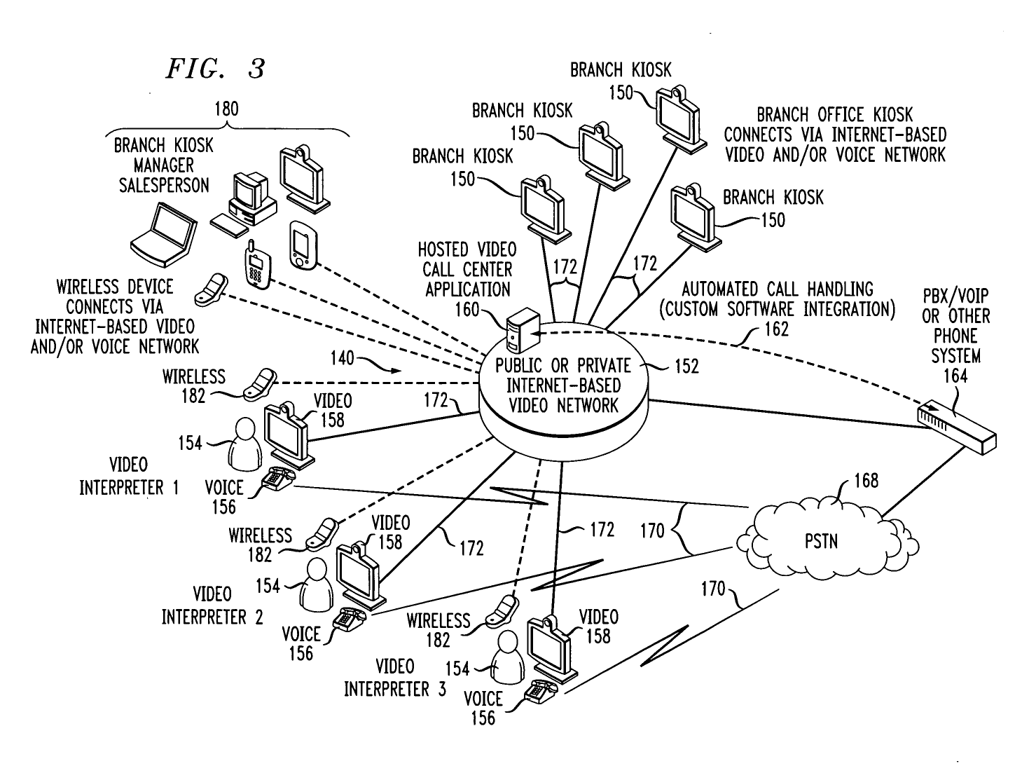

FIG. 3 shows a second embodiment of a language translation system 140 according to the invention. Components that are similar to or correspond with those in the embodiment of FIG. 2 have the same reference numerals increased by 100.

In FIG. 3, the branch kiosks 150 are arranged to link with a VOIP (Video Over Internet Protocol) network 152 using, e.g., a secured public access point that is not a part of the Glowpoint network 52 in FIG. 2. Also, instead of or in addition to the stationary branch kiosks 150, various mobile wireless devices 180 such as, for example, laptops, PCS and the like (some of which may also have touch screen capability), are provided at the branch to access the network 152 for both voice and video communication. Further, each of the interpreters 154 in FIG. 3 need not be confined to one specific location, since they may also have available mobile wireless devices 182 capable of connecting with the network 152 for voice and video communication. Also, in FIG. 3, a conventional PBXNOIP or equivalent voice telephone system 164 is set up in a known manner so as to perform the functions of the language interpreter provider 64 in the embodiment of FIG. 2.

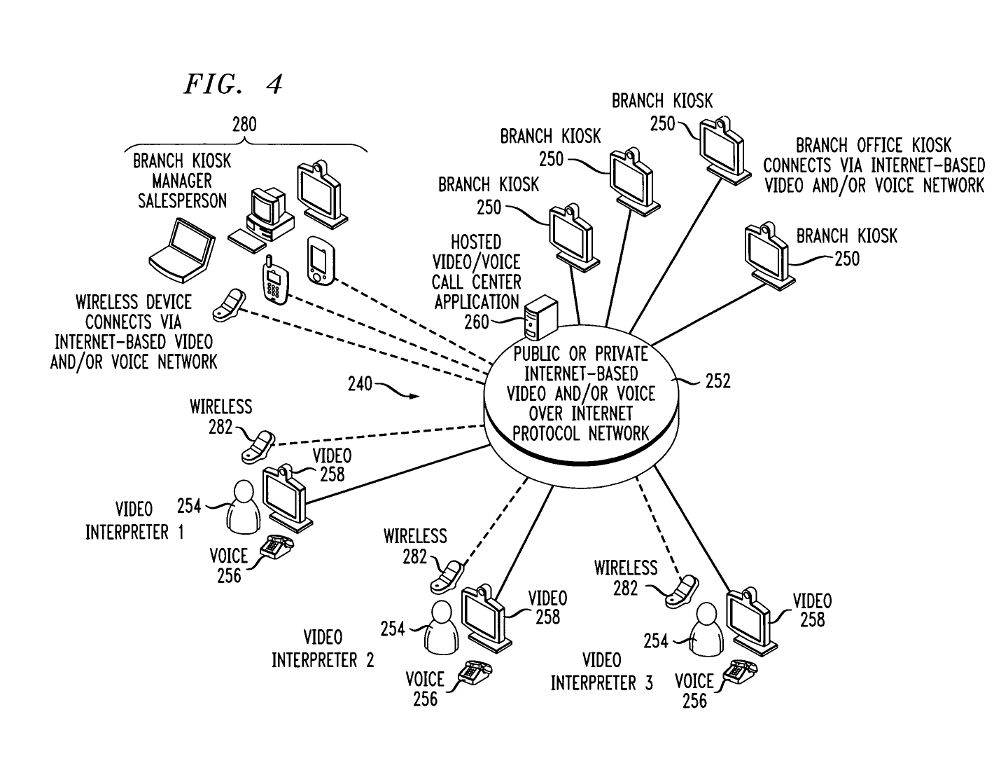

FIG. 4 shows a third embodiment of a language translation system 240 according to the invention. Components that are similar to or correspond with those in the embodiment of FIG. 2 have the same reference numerals increased by 200.

In the embodiment of FIG. 4, all video and voice traffic travels over the same stream, i.e., the use of a PSTN and telephone voice lines (70, 170) as in the embodiments of FIGS. 2 and 3, is avoided. The functions of the language interpreter provider 64 in the embodiment of FIG. 2, are managed by a processing unit 260 associated with a public or private network 252 that handles both high bandwidth video and voice over Internet protocols.

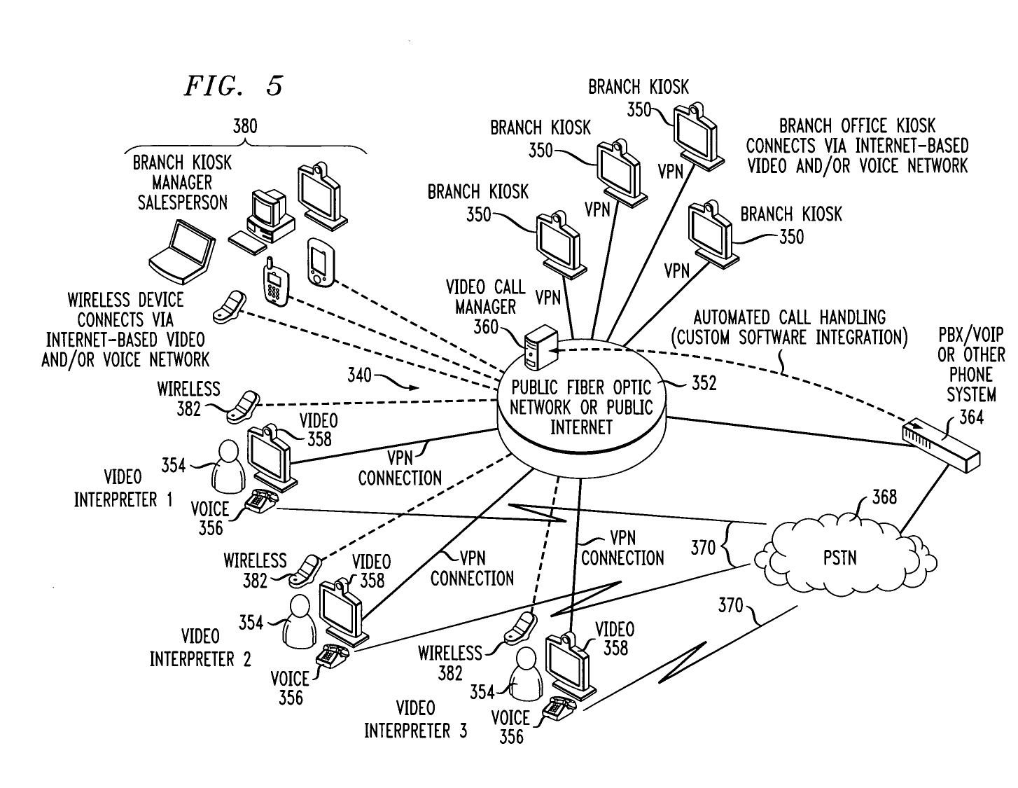

FIG. 5 shows a fourth embodiment of a language translation system 340 according to the invention. Components that are similar to or correspond with those in the embodiment of FIG. 2 have the same reference numerals increased by 300.

The embodiment of FIG. 5 resembles that of FIG. 3, except that in FIG. 5 an encrypted Virtual Private Network (VPN) is established in a known manner between the branch kiosks 350 and the interpreters 354 through either a public Internet or a public fiber optic network 352.

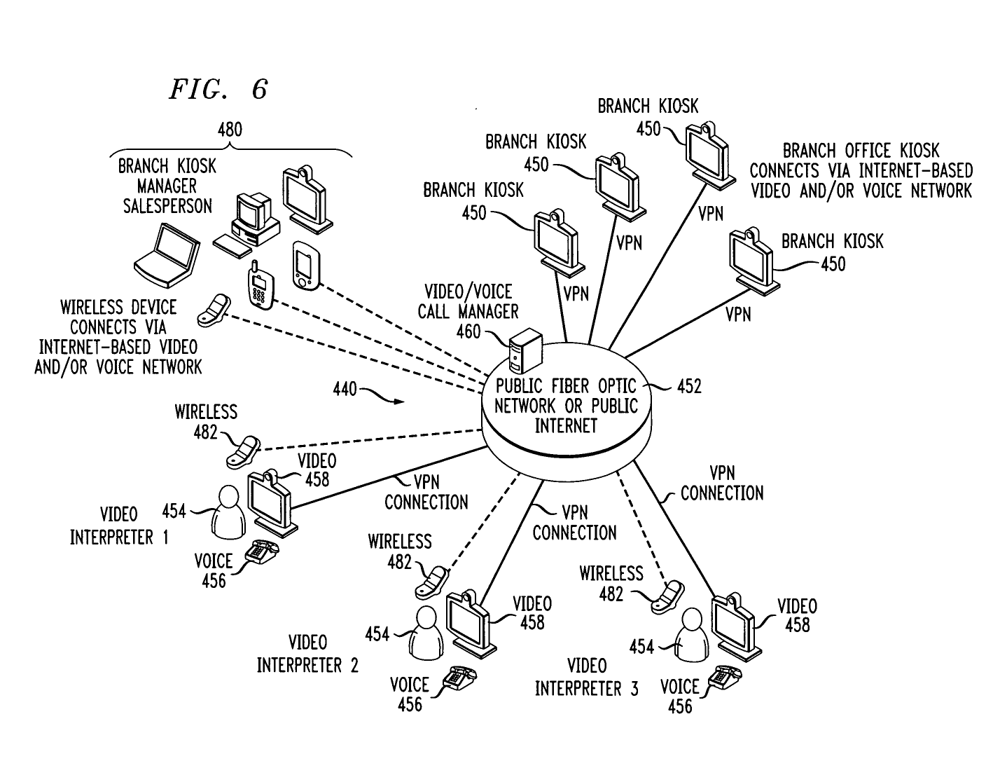

FIG. 6 shows a fifth embodiment of a language translation system 440 according to the invention. Components that are similar to or correspond with those in the embodiment of FIG. 2 have the same reference numerals increased by 400.

The embodiment of FIG. 6 resembles that of FIG. 4, except that all communications that occur within the system 440 are established using a VPN connection.

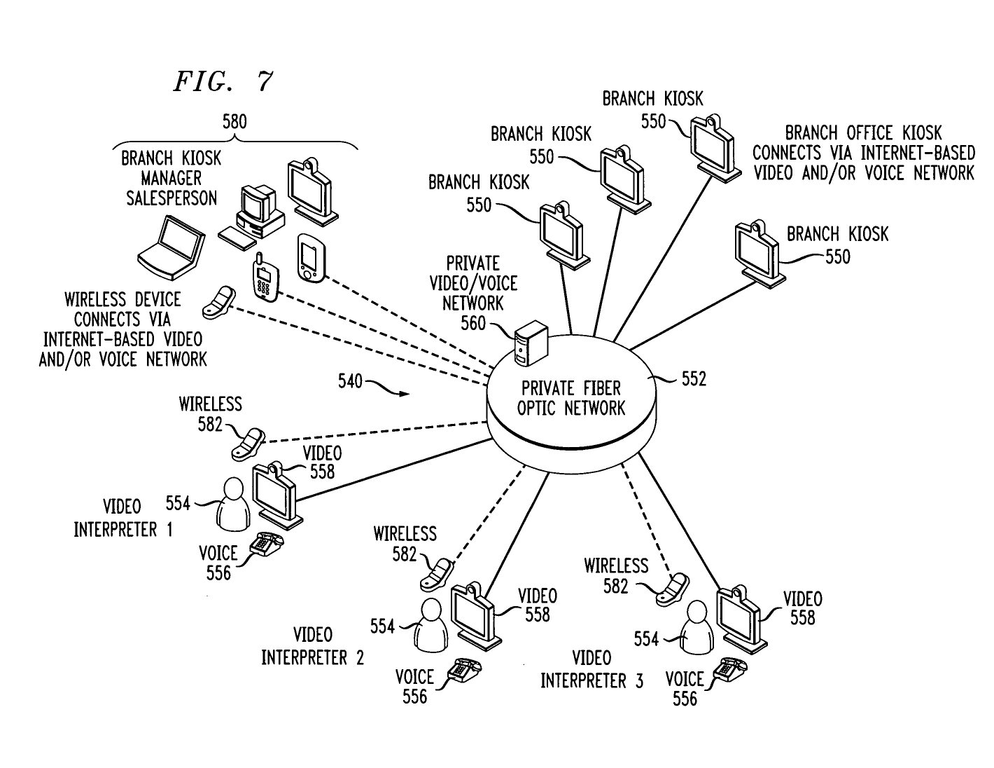

FIG. 7 shows a sixth embodiment of a language translation system 540 according to the invention. Components that are similar to or correspond with those in the embodiment of FIG. 2 have the same reference numerals increased by 500.

The embodiment of FIG. 7 resembles that of FIG. 6, except that all communications between individuals at one of the kiosks 550 and a selected interpreter 554, are conducted through a private fiber optic network 552. Accordingly, there is no need to establish the VPN connections that occur in the FIG. 6 embodiment.

While the foregoing represents preferred embodiments of the invention, it will be understood by those skilled in the art that various modifications and changes may be made without departing from the spirit and scope of the invention, and that the invention includes all such modifications and changes as come within the scope of the following claims.

1. A language translation system, comprising:
one or more kiosks arranged at a retail establishment or branch, wherein a given kiosk includes first audio and video equipment constructed and arranged for linking with a given network and for enabling persons at the kiosk to communicate with a selected language interpreter located off site;
second audio and video equipment constructed and arranged at the site of the interpreter for linking with the given network and for enabling the interpreter to communicate by voice and image with the persons at the kiosk; and
a processing unit associated with the network, wherein the processing unit is configured and programmed for (a) accessing a database representing a number of language interpreters, (b) selecting a certain interpreter from said database in response to a language choice entered by a person at the kiosk, and (c) connecting the first audio and video equipment at the given kiosk with the second audio and video equipment of the selected interpreter through the given network.

2. A language translation system according to claim 1, wherein the processing unit is configured and programmed for determining which of the language interpreters in said database is currently available according to information representing hours of availability for each of the interpreters.

3. A language translation system according to claim 1, wherein the processing unit is configured and programmed for bridging with an outside network to access the database of language interpreters.

4. A language translation system according to claim 1, wherein the processing unit is configured and programmed to initiate a telephone call to the selected interpreter before connecting the second audio and video equipment of the interpreter with the first audio and video equipment at the given kiosk.

5. A language translation system according to claim 4, wherein the language interpreters represented in said database have wired telephones for receiving the calls initiated by the processing unit.

6. A language translation system according to claim 4, wherein the language interpreters represented in said database have wireless telephones for receiving the calls initiated by the processing unit.

7. A language translation system according to claim 1, wherein the given network is a public or private Internet based video network.

8. A language translation system according to claim 7, wherein the given network is operative to handle voice over Internet protocol traffic.

9. A language translation system according to claim 1, wherein the first and the second audio and video equipment are constructed and arranged for linking via a virtual private network (VPN).

10. A language translation system according to claim 1, wherein the given network is a private fiber optic network.

11. A method of performing language translation services, comprising:
arranging one or more kiosks at a retail establishment or branch, and providing a given kiosk with first audio and video equipment for linking with a given network;
providing second audio and video equipment at sites of a number of language interpreters for linking the interpreters with the given network;
accessing a database representing the language interpreters;
selecting a certain interpreter from the database in response to a language choice entered by a person at the given kiosk; and
connecting the first audio and video equipment at the given kiosk with the second audio and video equipment of the selected interpreter through the given network;
thereby enabling persons at the kiosk to communicate with the selected language interpreter, and enabling the interpreter to communicate by voice and image with the persons at the kiosk.

12. The method of claim 11, including determining which of the language interpreters represented in the database is currently available according to information corresponding to hours of availability for each of the interpreters.

13. The method of claim 11, including bridging with an outside network to access the database of language interpreters.

14. The method of claim 11, including initiating a telephone call to the selected interpreter before connecting the second audio and video equipment of the interpreter with the first audio and video equipment at the given kiosk.

15. The method of claim 14, including providing the language interpreters represented in the database with wired telephones for receiving the initiated calls.

16. The method of claim 11, including providing the language interpreters represented in the database with wireless telephones for receiving the initiated calls.

17. The method of claim 11, wherein the connecting step is performed using a public or private Internet based video network.

18. The method of claim 11, wherein the connecting step is performed using a network that is operative to handle voice over Internet protocol traffic.

19. The method of claim 11, including linking the first and the second audio and video equipment with one another through a virtual private network (VPN).

20. The method of claim 11, including linking the first and the second audio and video equipment with one another through a private fiber optic network.
